(19) United States
(12) Patent Application Publication
(10) Pub. No.: US 2001/0023582 A1
(43) Pub. Date: Sep. 27, 2001

(54) Apparatus and method for active reduction of the noise emission from jet engines and for jet engine diagnosis

(76) Inventor: Friedmund Nagel, Zell (DE)

Correspondence Address: Jeffrey C. Hood, Conley, Rose & Tayon, P.C., P.O. Box 398, Austin, TX, 78767, US

(21) Appl. No.: 09/765,774

(22) Filed: Jan. 19, 2001

(30) Foreign Application Priority Data
Jul. 22, 1998 (DE) 19832963.6
Sep. 23, 1998 (DE) 19843615.7

(51) Int. Cl. F02C 7/24

(52) U.S. Cl. 60/204; 60/725

(57) ABSTRACT

An apparatus and a method for active reduction of the noise emission from a jet engine having an air inlet, a gas outlet and an engine arranged between the air inlet and the gas outlet. A first acoustic transducer is arranged in the air inlet upstream of the engine and/or in the gas outlet downstream of the engine in order to convert sound waves into first signals that are a measure of the frequency, amplitude and phase of the sound waves. An electronic control unit converts the first signals into second signals. A second acoustic transducer is centrally arranged in the air inlet upstream of the engine and/or in the gas outlet downstream of the engine in order to convert the second signals into compensation sound waves whose frequency, amplitude and phase are such that the sound waves and the compensation sound waves at least partially cancel one another out.

### FIELD OF THE INVENTION

The present invention relates to an apparatus and a method for active reduction of the noise emission from jet engines and for their diagnosis.

### DESCRIPTION OF THE RELATED ART

The internal noise, as well as the external noise, from jet aircraft are nowadays governed primarily by the noise emissions from their jet engines. As air traffic increases, both the reduction of the internal noise in aircraft and, in particular, the reduction of the aircraft noise to which those living close to airfields are subjected are becoming more important.

Attempts are frequently made to achieve a reduction in the noise level in the interior of aircraft by further improving passive sound-proofing and silencing. The efforts to reduce noise also include measures relating to the decoupling of structure-born sound. In this case, the aim is to prevent the sound emitted from a jet engine being transmitted to other parts of the aircraft, particularly to parts which are connected to the interior of the aircraft.

Furthermore, so-called DVAs (Dynamic Vibration Absorbers) are used which, within a defined, relatively narrow frequency spectrum, use resonance to absorb a portion of the vibration and oscillations transmitted through the aircraft fuselage structure.

Finally, in individual cases, noise compensation systems are also installed within the internal cladding of the passenger area of the aircraft fuselage. In this case, loudspeakers are used to emit compensation sound, in order to reduce penetrating engine noise.

The measures described for soundproofing, silencing, structure-borne sound decoupling, etc., generally lead to increased weight. In general, all the noise protection measures which increase weight reduce the efficiency of aircraft by reducing the payload and increasing the fuel consumption.

Furthermore, effective noise reduction is linked to high development costs for locating and combating the individual noise sources and the noise transmission paths. In the end, this cost is incurred for all new internal equipment in a jet aircraft. In order to design the noise reduction to be effective in the long term, both the quality and aging of the materials used and the effectiveness of the processing techniques used must be investigated and approved using costly procedures. Another general disadvantage of the systems mentioned above is that they do not result in any reduction in the noise emission in the area outside the aircraft.

In the past, various design measures were taken to reduce the external noise emission from jet engines. For example, the development of bypass engines led to a reduction in the noise emission. However, this noise reduction has still not reached a satisfactory level.

U.S. Pat. No. 5,325,661 relates to a noise suppressor for jet flow mixers for high-speed jet aircraft. This suppressor mixes a high-speed air flow with a lower speed air flow. Acoustic waves which are produced by obstacles fitted in the jet nozzle are used to suppress noise.

U.S. Pat. No. 5,758,488 describes a system for reducing the noise from aircraft turbines. This essentially comprises a noise reduction unit, a fan, an air flow diverter, a core flow expansion chamber device, a thrust-reverser and a tailpipe.

In these solutions, noise reduction is attempted by means of flow-mechanics improvements. Furthermore, apparatuses for active noise reduction have been proposed in the prior art in order to reduce the external noise from jet engines.

PCT Application WO 96/12269 describes an electro-pneumatic apparatus that operates with a reference signal. This reference signal is derived from the fan angular speed or blade passing frequency and from error signals which are sensed by acoustic transducers. The signals are used to actuate valves on the fan stage, from which valves an air flow whose pressure and temperature are regulated is directed for noise compensation.

PCT Application WO 96/11465 likewise describes an apparatus for actively reducing engine noise in the region of the engine inlet. The apparatus has sensors to measure the fan blade passage frequency and sensors to measure residual noise. Both sensors supply signals which are passed on to a control unit. The control unit is connected to loudspeakers which generate cancelling noise in order to reduce noise from the aircraft propulsion system. The sensors for measuring the blade passing frequency and the loudspeakers are fitted circumferentially in the wall of the engine inlet.

PCT Application WO 98/12420 also relates to an apparatus for the active reduction of the rotoring machinery noise from rotor blades in aircraft engines. For this purpose, a fluid is passed at high pressure along the path of the source signal so that an inverted pressure wave is created relative to the pressure wave of the source signal.

U.S. Pat. No. 3,936,606 describes an apparatus for reducing the acoustic noise of, among other things, a gas turbine engine. Here, the acoustic transducers are arranged at the outside of the engine or are spread over the complete outlet opening.

### SUMMARY OF THE INVENTION

The present invention provides an apparatus and a method for active reduction of the noise emission from jet engines. In some embodiments, a high level of noise reduction may be achieved in a way that is as simple as possible and is effective for an extended duration. In particular, some embodiments may be applicable in controlled acoustic conditions and may avoid requiring major changes to the engine. Various embodiments are intended to be applicable to both the inlet and outlet region of the engine.

In one embodiment, an apparatus for the active reduction of the noise emission of a jet engine is disclosed. The jet engine includes an air inlet, a gas outlet and the actual engine. The actual engine is arranged between the air inlet and the gas outlet. The apparatus includes a first acoustic transducer in the air inlet upstream of the engine and/or in the gas outlet downstream of the engine configured to convert sound waves into first signals. The first signals are a measure of the frequency, amplitude and phase of the sound waves. The apparatus also includes an electronic control unit configured to convert the first signals into second signals and a second acoustic transducer configured to convert the second signals into compensation sound waves whose frequency, amplitude and phase are such that the sound waves and the compensation sound waves at least partially cancel one another out. According to some embodiments, the second acoustic transducer may be arranged centrally in the air inlet upstream of the engine and/or centrally in the gas outlet downstream of the engine. In some embodiments, additional acoustic transducers may be included.

In the context of the present disclosure, the term jet engine also covers turboprop jet engines and turbines for supplying an aircraft with electrical power when the propulsion turbines are not in use, or so-called “Auxiliary Power Units (APU).”

The first acoustic transducer may be a microphone configured to pick up the sound waves emitted by the jet engine, and the second acoustic transducer may be a loudspeaker configured to emit compensation sound waves. Other acoustic transducers that achieve the same purpose may be used in other embodiments. For the purposes of the present invention, the term acoustic transducer may also refer to a plurality of acoustic transducers. In some embodiments, a plurality of acoustic transducers may be used to cover the entire relevant sound propagation area, the relevant sound front planes and the required frequency range.

The first acoustic transducer may be configured to convert the sound waves into electromagnetic or optical first signals, which represent a measure of the frequency, amplitude, and phase of the incident sound waves. These first signals may be processed using a microprocessor. For example, a Fourier analysis can be carried out in order to break the complex sound pattern down into individual oscillations. Furthermore, specific frequency components, such as those outside the spectrum that is audible to human beings, may be excluded from compensation, unless compensation of those frequency components is regarded as being necessary. For example, in some embodiments, such compensation may be desirable for reasons of physical noise perception. In one embodiment, the noise compensation achieved by the second acoustic transducer is intended to be as complete as possible so that the remaining residual noise level is as low as possible.

The second acoustic transducer is arranged centrally in the air inlet upstream of the engine and/or centrally in the gas outlet downstream of the engine. The central arrangement of the second acoustic transducer is chosen since the symmetrical acoustic conditions may considerably enhance the effectiveness of the noise compensation and simplify the noise compensation system overall. In particular, inaccuracies in the noise compensation resulting from delay time differences for sound waves from a number of loudspeakers not located centrally may be avoided. In the same way, disturbing interference which can occur if a plurality of loudspeakers are arranged other than centrally, in particular if the loudspeakers are located opposite to each other, may also be avoided.

The first acoustic transducer is also preferably arranged centrally in the air inlet upstream of the engine and/or centrally in the gas outlet upstream of the engine.

In the context of the present invention, the term “centrally” also covers an acoustic transducer arranged essentially in the middle of the inlet and/or outlet. Jet engines frequently do not have entirely circular cross-sectional areas in the engine inlet and in the gas outlet. In this case, the acoustic transducers may then be arranged essentially centrally, in such a way that they ensure largely symmetrical acoustic conditions.

Generally, jet engine noise is propagated primarily forwards out of the engine inlet and backwards out of the gas outlet in the direction of the longitudinal axis of the engine. The acoustic transducers are therefore preferably arranged and aligned so that the compensation sound is emitted in a plane which is oriented essentially at right angles to the longitudinal axis of the engine, and thus parallel to its main sound front plane. Secondary sound front planes which differ from this orientation may be compensated by inclining the emission angle of a second acoustic transducer (which may be split on a sector basis) or of a plurality of second acoustic transducers.

The arrangement and alignment of the acoustic transducers in the jet engine, particularly if they are retrofitted to an already existing jet engine, may also have to take aerodynamic aspects into account. Given the high airspeeds in jet engines, it may be desired that the transducers not create excessive drag or reduce the performance of the engine beyond a negligible extent. It may therefore be advantageous to arrange the acoustic transducers upstream of the front cone on the hub of the engine low-pressure compressor in the region of the air inlet of the engine. In the rear exhaust area of the engine, the acoustic transducers may preferably be fitted downstream of the tail cone of the engine, that is to say in its wind shadow. This not only reduces the drag but also improves the mechanical robustness of the arrangement with regard to the forces acting on it from the flowing air masses.

One preferred embodiment of the apparatus has a first acoustic transducer and a second acoustic transducer both in the air inlet upstream of the engine and in the gas outlet downstream of the engine. This allows not only the noise emitted forwards from the jet engine but also the noise emitted to the rear to be combated. In this case, the noise compensation systems can operate completely independently of one another.

The apparatus for reducing noise emission preferably contains a cone which is fitted centrally in the air inlet of the jet engine and has at least one opening, in which case the first acoustic transducer and the second acoustic transducer are fitted in the cone in such a manner that they are acoustically connected to the air inlet via the opening. The noise compensation unit comprising the two acoustic transducers and, possibly, a microprocessor can thus be aerodynamically accommodated in the air inlet before the direct incident flow strikes it and so that it is protected against dirt. At the same time, the noise compensation unit is able to act optimally on the compensation area in the air inlet. Furthermore, the aerodynamic optimization of the cone ensures that the pressure conditions are comparable not only in the region of the acoustic transducers but also in the noise compensation area.

In order to avoid icing in certain weather conditions, the cone and the vanes of the noise compensation unit in the air inlet of the engine may be electrically heated.

In the rear gas outlet of the jet engine, the acoustic transducers are preferably fitted on a central holder which is matched, in terms of flow mechanics, to the tailpiece of the engine. Aerodynamic optimization is also desirable here in order to produce similar pressure conditions in the region of the acoustic transducers and in the region of the compensation area. Aligning the acoustic transducers towards the rear protects them from being subjected to the direct incident flow. Thus, this orientation not only prevents a noise signal being produced by the incident flow but also protects the acoustic transducers from wear and dirt.

A further preferred embodiment of the apparatus includes a cooling device for cooling the second acoustic transducer and, possibly, the first acoustic transducer in the gas outlet. For this purpose, the acoustic transducer or transducers may be screened, preferably by means of cladding, from being acted on directly by the gas flow. It is particularly preferable for the noise compensation unit to be installed in an outer cone. For cooling purposes, external air or, in the case of bypass engines, relatively cool air from the bypass flow, can be tapped off and introduced into this outer cone within one or more vanes. The cooling air can then flow over the acoustic transducers and outwards into the gas outlet from the engine. This cooling airflow may also prevent the production of reverse-flow hot-gas turbulence, which could impinge on the acoustic transducers. In bypass engines, the cooling air continues to flow automatically as a result of a pressure differential, provided there is a sufficient pressure difference between the bypass flow and the gas flow. This is reinforced by the dynamic pressure produced upstream of the acoustic transducers by the gas flow in the gas outlet from the engine. If the aircraft speed is sufficient, particularly in the case of plain jet engines, the cooling air may also originate from the environment. During flight, the subsequent flow of external air can be provided by the ram-air pressure at a point which is suitable for use as an air inlet. This allows the rear noise compensation unit to be well controlled thermally.

If operating states occur in which the natural subsequent flow of the air is not sufficient for cooling, such as during engine start up or shutdown or when using thrust reversal, the cooling air can be assisted by a fan. This may also compensate for turbulence.

The effectiveness of the cooling for the noise compensation unit can be assisted by choosing suitable materials with low thermal conductivity for the outer cone and for the vanes which carry the air and, where necessary, by means of surface treatments which reflect thermal radiation.

The apparatus can also be used for diagnosis of the condition and operation of the jet engine. For this purpose, the apparatus may include a comparison unit for comparing the first signals from the first acoustic transducer with nominal signals. The frequency of the sound waves being considered need not necessarily be determined with a high degree of accuracy in this case. If a very narrow sound frequency spectrum is present, it may be possible in some circumstances to dispense with frequency analysis altogether and instead regard all the frequencies which occur within a range as a representative frequency. It may be sufficient to be able to distinguish between sound waves at a different frequency in order to break down the sound pattern to the level required in practice. This level may vary depending on the application and depending on the requirements for the accuracy of the sound analysis.

An actual sound pattern is thus compared with a nominal sound pattern. This comparison allows diagnosis of the jet engine, since jet engines have a characteristic sound pattern for each of the various operating states. Disturbances such as those caused by damage to the propulsion system disturb this sound pattern. If the first acoustic transducer is arranged in the inlet cone of the engine or its exhaust area, it may be possible to draw further conclusions about wear, combustion-chamber deposits, dirty combustion due to poor fuel quality or mechanical damage such as that due to a birdstrike. In this case, it is often possible to deduce the nature of the defect from the nature of the disturbance in the sound pattern. In many cases, this conclusion about the condition (the long-term state) and/or the operation (the operating state or temporary state) of the jet engine may require further processing steps, and in particular, further comparison steps. However, at the very least, the presence of a defect can normally be detected without this further signal processing.

The first signals obtained in the first acoustic transducer, parts of these first signals, or secondary signals derived from these first signals may be used for the diagnosis process on the jet engine. The first signals obtained generally contain information about the frequency, the amplitude and the phase of a plurality of sound waves. However, in some cases, diagnosis of the jet engine can be carried out solely on the basis of the frequency spectrum without considering the amplitude and phase. In these cases, the amplitude may only need to exceed a specific limit value for the diagnosis of the frequency occurring. This limit value may be determined simply by the response threshold of the first acoustic transducer. If, for example, discrepancies occur between a predetermined variable or meaning of the actual spectrum and the nominal spectrum, these can be used to draw the above mentioned conclusions about the condition or operation of the jet engine. The nominal values may be determined in advance for various typical operating states, such as different engine speeds, various load ranges, or operating temperatures, and these nominal values may be stored in the comparison unit so that it is possible to compare the nominal values with the actual values in daily operation for a number of operating states. In this case, it may not be necessary to use all the information received from the noise compensation unit. For example, it may not be necessary to compare a full frequency spectrum of actual values with the corresponding nominal values. Selective comparison may be sufficient. The comparison itself may be carried out in a microchip or microcomputer which is a part of the comparison unit.

The apparatus preferably also has an output unit for outputting a warning signal when at least one previously defined discrepancy occurs between the first signals from the first acoustic transducer and the nominal signals. Such a warning signal may comprise a straightforward warning by means of a warning lamp or a demand to change the operating conditions. For example, the warning signal may include a demand to reduce the thrust. For the purposes of this disclosure, such a warning signal may also include a signal which automatically results in a specific consequence, such as load matching, a change in the ignition timing, emergency disconnection or information being sent to a control center by radio informing the control center that a specific malfunction has occurred.

The apparatus preferably also comprises a selection unit for selecting first signals from the first acoustic transducer which correspond to one or more specific frequency ranges, in order to carry out the signal comparison. This allows selective comparison of frequencies, which requires less computer capacity and can therefore be carried out more quickly.

A further advantageous embodiment of the apparatus has a service monitoring unit for calculating and indicating the date when the next servicing for the jet engine is due on the basis of the time behaviour of signals from the first acoustic transducer in comparison to the nominal signals for the respective operating state. The service monitoring unit monitors the time behaviour of the actual values of all or part of first signals such as the frequency and uses this behavior to draw conclusions about when the next inspection of the engine is required. This is feasible since certain frequencies in the sound spectrum of the exhaust gases from an engine occur with increasing frequency when the engine is ready for inspection or overhaul. The present embodiment of the invention can thus be used to define individual inspection intervals which may result in both considerable cost savings as a result of the average inspection intervals becoming longer and an improvement in operating safety by shortening inspection intervals. Particular advantages are feasible in this case. For example, the fact that an inspection is due on the aircraft engine may be reported directly to an administration center, which may then directly assign the aircraft to inspection when it next arrives at a servicing airport or support-base airport.

In another advantageous embodiment of the apparatus, at least one structure-borne sound sensor is arranged in or on the jet engine, preferably on its casing. This sound sensor may be used to associate the source of malfunctions with a specific section of the jet engine. If, as described above, a malfunction is found in the propulsion system, it is advantageous to determine the nature and location of the malfunction's source. The nature of the malfunction can frequently be deduced from the actual signals (i.e. the frequency spectrum received). If certain malfunctions occur exclusively in certain parts of the jet engine, the nature of the malfunction also makes it possible to deduce the source of the malfunction. For example, it may be possible to pinpoint compressor instabilities. If this is not the case, however, it may not be possible to locate the origin of the malfunction. For these situations, the present embodiment of the apparatus offers the capability to localize the origin of a malfunction by fitting one, or preferably a number of, structure-borne sound sensors to the casing of the jet engine. The results obtained from the sound sensors can be compared with one another so that the origin of a defect can be located. For example, such structure-borne sound sensors can be fitted to the casing of the jet engine. One of the sound sensors may be fitted at the level of the first-stage compressor, another at the level of the main compressor, and yet another at the turbines. If, for example, a malfunction occurs in the main compressor, the corresponding structure-borne sound sensor will normally exhibit the greatest change in the sound profile, from which the conclusion can be drawn that the malfunction source is located in the main compressor.

A further advantageous refinement of the apparatus includes a unit for synchronization of two or more engines. This unit compares the first signals from the first acoustic transducers associated with the engines to be synchronized and then varies engine control parameters such as the fuel supply for the engines in such a manner that the first signals from the first acoustic transducers become more consistent with one another. In aircraft, the jet engines must run synchronously in order to avoid acoustic disturbances such as beat frequencies or rumbling noises. These days, this engine synchronization is normally carried out by comparing the engine speeds. In practice, however, this engine speed comparison is subject to inaccuracy and a time delay, which hinders rapid and efficient synchronization. In the context of the described preferred embodiment, it is possible to compare the operating state of the engines with one another by comparing the first signals from the first acoustic transducers with one another and adapting the engine control parameters so that these first signals become consistent with one another. This results in simple, effective and rapid engine synchronization.

A further preferred embodiment of the apparatus includes a monitoring unit that may preferably be used for calibration of a tachometer associated with a jet engine. Conventionally, the output from tachometers is based on measuring the rotation frequency of a rotating part, such as the central drive shaft of the jet engine. By virtue of this principle, such measurements include a range of error sources that can lead to incorrect measurements. These measurement errors can be identified and corrected using a monitoring unit. The first signals from the first acoustic transducers in the engine are compared with the output from the tachometer and, if necessary, the tachometer is corrected. This comparison is possible since each jet engine speed corresponds to a specific engine sound pattern. In addition to monitoring correct operation, it is also possible to calibrate the tachometer in defined sound propagation conditions. This can be done at predetermined time intervals or otherwise when required, such as when a considerable discrepancy is found between the output from the tachometer and the engine speed determined by evaluation of the sound pattern.

A method is also provided for active reduction of the noise emission from a jet engine that includes an air inlet, a gas outlet, and the actual engine arranged between the air inlet and the gas outlet. The method comprises the following steps: (a) conversion of sound waves into first signals which are a measure of the frequency, amplitude and phase of the sound waves by a first acoustic transducer that is arranged in the air inlet upstream of the engine and/or in the gas outlet downstream of the engine, (b) conversion of the first signals into second signals by an electronic control unit, and (c) conversion of the second signals into compensation sound waves whose frequency, amplitude and phase are such that the sound waves and the compensation sound waves at least partially cancel one another out by a second acoustic transducer that is arranged centrally in the air inlet upstream of the engine and/or centrally in the gas outlet downstream of the engine.

Thus, an apparatus and a method for active reduction of the noise emission from a jet engine are provided. Compensation of the noise at the noise source results in a reduction in noise emission from the aircraft for both the environment and for the occupants in a simple and efficient manner. The apparatus and the method may offer these advantages with minimal use of energy, little design complexity, and negligible loss of performance, while at the same time saving weight for design noise protection measures on the aircraft. At least the second acoustic transducer is arranged centrally in the engine, thus creating the best possible symmetrical, laterally limited, acoustic conditions. The compensation sound waves can be emitted and, if appropriate, the sound can be received essentially parallel to the main noise oscillation plane, thus achieving high noise compensation efficiency. The apparatus may be mounted in a simple manner on the engine without having to carry out any major design changes. The apparatus may thus also be suitable for retrofitting to engines which are already in use. The noise compensation apparatus may be used not only in the air inlet but also in the gas outlet. This allows noise compensation at both ends of the engine. With a comparison unit added to it, the apparatus may also be used for diagnosis of jet engines. The precise condition of a jet engine can thus be determined at any time.

### BRIEF DESCRIPTION OF THE DRAWINGS

The invention will be described in the following text using the attached figures by way of example, in which:

FIG. 1 shows an embodiment of the apparatus for reducing the noise emission from jet engines, including a diagnostic function;

FIG. 2 shows a detail from the rear engine end of the apparatus shown in FIG. 1, with acoustic transducers cooled by an air flow; and

FIG. 3 shows a schematic diagram illustrating the operation of the embodiment shown in FIG. 1.

### LIST OF REFERENCE TERMS

1 Jet engine

2 Suspension

3 Air inlet

4 Gas outlet

5 Engine

6, 6′ Noise compensation unit (pair of first and second acoustic transducers)

7, 7′ First acoustic transducer (microphone)

8, 8′ Second acoustic transducer (loudspeaker)

9, 9′ Additional first acoustic transducer (microphone) within the retaining vanes 11, 11′

10, 10′ Correction microphones

11, 11′ Retaining vanes

12 Cone

13 Opening in the cone 12

14 Outer cone

15 Tailpiece of the engine 5

16, 16′ Electronic control unit (with frequency analysis unit)

17, 17′ Comparison unit

18 Diagnosis terminal

19 Outer casing of the engine 5

20 Inner casing of the engine 5

21 Structure-borne sound sensor

22 Structure-borne sound sensor

23 Structure-borne sound sensor

30 Sound waves

31 Signals from the first acoustic transducers 7, 7′

32 Signals from the electronic control unit 16, 16′

33 Compensation sound waves from the second acoustic transducer 8, 8′

The reference numbers followed by an apostrophe in each case denote components in the rear part of the engine.

### DETAILED DESCRIPTION OF EMBODIMENTS

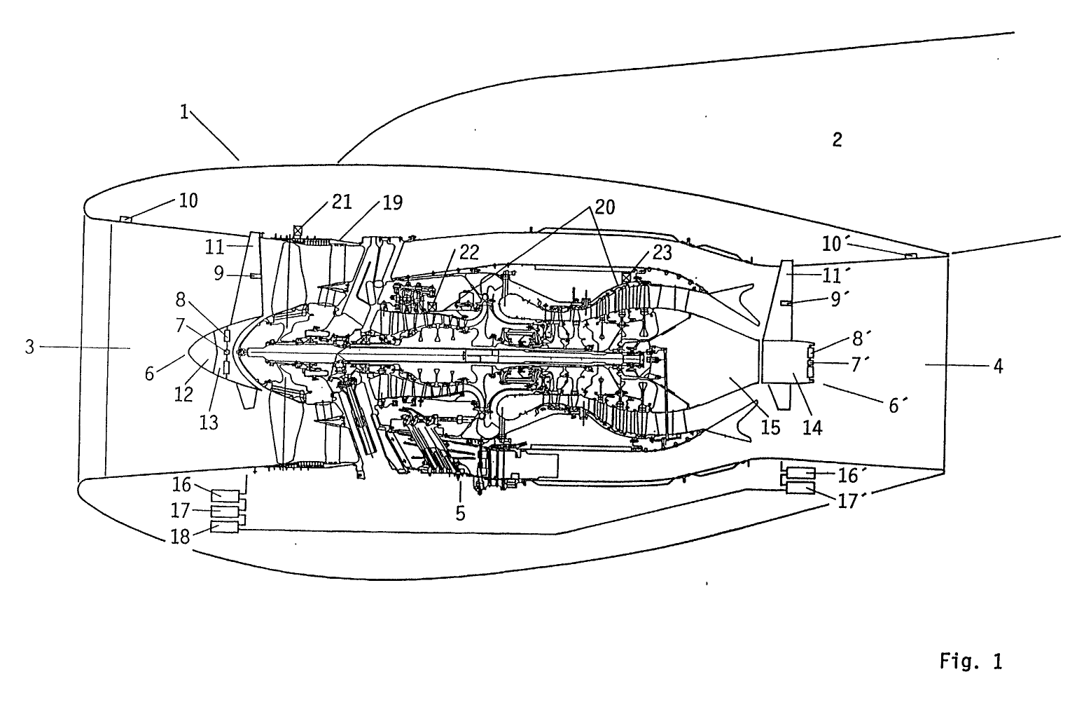

FIG. 1 shows a jet engine 1, in this case a twin-spool bypass engine, which is arranged on a suspension device 2. The jet engine 1 is equipped with an apparatus to reduce noise emission. The jet engine 1 has a front air inlet 3 and a rear gas outlet 4. The actual engine 5 is fitted between the front air inlet 3 and the rear gas outlet 4. The jet engine 1 shown in FIG. 1 has both in the air inlet 3 as well as in the gas outlet 4, a first acoustic transducer 7 and/or 7′. The first acoustic transducer 7 may be a microphone, and a second acoustic transducer 8 and/or 8′ may be a loudspeaker. The front noise compensation unit 6 is monitored by an electronic control unit 16, and the rear compensation unit 6′ is monitored by an electronic control unit 16′.

The front noise compensation unit 6 comprises the acoustic transducers 7, 8, and is fitted in a cone 12 in the air inlet 3. The cone has an opening 13 for the acoustic transducers 7, 8 to communicate acoustically with the compensation area in the air inlet 3. The noise compensation area, bounded by the inner surface of the air inlet 3, in this case has a symmetrical conical shape, which leads to defined acoustic conditions. The opening 13 in the cone 12 continues this symmetry. The microphone 7 and the loudspeaker 8 (which is in this case configured in an annular shape) are therefore arranged centrally. Design characteristics, in particular aerodynamic characteristics, may, however, necessitate a different arrangement, which is not completely but is nevertheless essentially central. Three retaining vanes, which are provided at uniform angular intervals from one another and of which only one can be seen completely in FIG. 1 (vane 11), are used for suspension of the cone 12. This is arranged a short distance in front of the front end of the low-pressure compressor, which likewise has a conical shape. This design leads to the noise compensation system causing only a small amount of additional drag. This drag can be further reduced by aerodynamically advantageous shaping of the vanes.

At the rear end of the engine, the microphone 7′ and the loudspeaker 8′ are fitted on a platform which is matched, in terms of flow mechanics, to the tailpiece 15 of the engine 5 in order to avoid the formation of turbulence which could lead to increased drag and to poor acoustic conditions for noise compensation. In this case, the noise compensation unit 6′ is fitted in the wind shadow of the engine 5. This unit is held by three vanes which are fitted at equal angular intervals from one another, only one of which is shown completely (vane 11′). The retaining vanes are preferably shaped aerodynamically. In this way, turbulence can be avoided and drag can be minimized.

The noise compensation units 6, 6′ with the first acoustic transducers 7, 7′ and the second acoustic transducers 8, 8′ are supplied with electrical power via supply lines in the retaining vanes 11, 11′. The connections to the control units 16, 16′ (which are fitted in the engine nacelle) also run in the retaining vanes 11, 11′. The vane 11′ can also be used to pass cooling air to the holder, if it is necessary to cool the rear noise compensation unit 6′ and the acoustic transducers 7′, 8′.

FIG. 1 also shows two additional microphones 9, 9′, that are arranged upstream of the noise compensation plane within the retaining vanes 11, 11′. The microphones 9, 9′ are used for supplementary detection of the engine noise for measurement purposes. The acoustic measurement is carried out facing away from the flow through an opening on the rear edge of the vanes 11, 11′. The rear microphone 9′ is thermally protected in an equivalent manner to the noise compensation unit 6′, as is described in the following text.

Two correction microphones 10, 10′ are also shown, which are arranged inside the jet engine 1, downstream of the noise compensation plane, in the wall of the air inlet 3 or of the gas outlet 4. The correction microphones 10, 10′ record any residual noise from the jet engine 1 which has not been compensated for, and are thus used to monitor the noise compensation.

The present embodiment of the apparatus furthermore comprises devices for diagnosis of the condition or operation of the jet engine 1. The first signals, which represent the noise in the air inlet 3 or gas outlet 4 of the jet engine, are supplied by the first acoustic transducers 7, 7′ to the electronic control unit 16, 16′, where they are processed for noise compensation. The comparison units 17, 17′ either receive the data required for the comparison of the nominal and actual values described above from the electronic control units 16, 16′, or receive the first signals directly from the first acoustic transducers 7, 7′.

FIG. 1 also shows a diagnosis terminal 18 for comparison of the output signals from the two comparison units 17 and 17′. Discrepancies between the actual value signals and nominal value signals which have been determined by the front comparison unit 17 are compared in the unit 18 with the corresponding discrepancies which have been found by the rear comparison unit 17′ in order to make a reliable and/or differentiated statement about any malfunction which may possibly have occurred. Both the nature of the malfunction as well as the location of the source of the malfunction can be better analyzed in this way. Interfaces for external use of the diagnosis data are accommodated in the diagnosis terminal 18. For example, interfaces may include a data line to the cockpit, a data radio, a floppy disc drive, or a screen.

FIG. 1 furthermore shows three structure-borne sound sensors 21, 22 and 23. The sensor 21 is fitted to the outer casing 19 of the engine 5, and the sensors 22 and 23 are fitted to the inner casing 20 of the engine 5. They are distributed and arranged in such a manner that the location of any malfunction which occurs and is diagnosed, for example, by the front comparison unit 17 or the rear comparison unit 17′ may be better localized. This is because many defects cause structure-borne sound in addition to a differentiated airborne sound spectrum. The structure-borne sound may be more or less characteristic, but in any case it allows its local source to be identified. A defect can thus be localized more reliably and more quickly so that, for example, repair measures which have to be initiated can be determined in advance. The signals from the structure-borne sound sensors 21, 22, 23 are transmitted to the comparison units 17, 17′ and/or to the diagnosis terminal 18.

The present embodiment of the apparatus may offer the capability for jet engine condition and operation diagnosis in a simple and cost-saving manner.

In order to prevent icing of the front acoustic transducer unit 6 in certain weather conditions, the inlet cone 12 and the vanes 11 may also be electrically heated. The electrical power for the heating elements is then preferably supplied through the vanes 11.

The apparatus shown in FIG. 1 for reducing noise emissions from a jet engine may be arranged as an addition to an existing engine. In the case of new engine designs, integrated arrangements may also be provided. These integrated arrangements may be better aerodynamically matched.

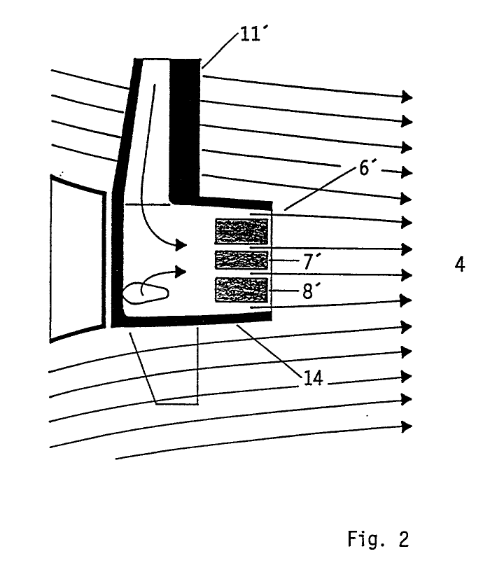

FIG. 2 shows a detail of the apparatus from FIG. 1. An outer cone 14, in which the compensation unit 6′ is mounted at a distance, is provided in order to cool the rear noise compensation unit 6′ and the acoustic transducers 7′ and 8′. In order to cool the noise compensation unit 6′, cooling air is passed through the retaining vanes 11′ into the outer cone 14. The cooling air is introduced into the rear part of the outer cone 14 and then flows over the acoustic transducers 7′, 8′, and outwards into the gas outlet 4. At the same time, the cooling airflow prevents the production of reverse-flow hot-gas turbulence, which could impinge on the acoustic transducers 7′, 8′. The outer cone 14 has appropriate openings for this purpose. For example, external air or, in the case of the illustrated bypass engine, relatively cool air from the bypass flow, can be tapped off for cooling. If necessary, the cooling air is conveyed by means of a fan during the process of starting up or shutting down the engine. The rear noise compensation unit 7′, 8′ can be thermally well controlled in the described manner.

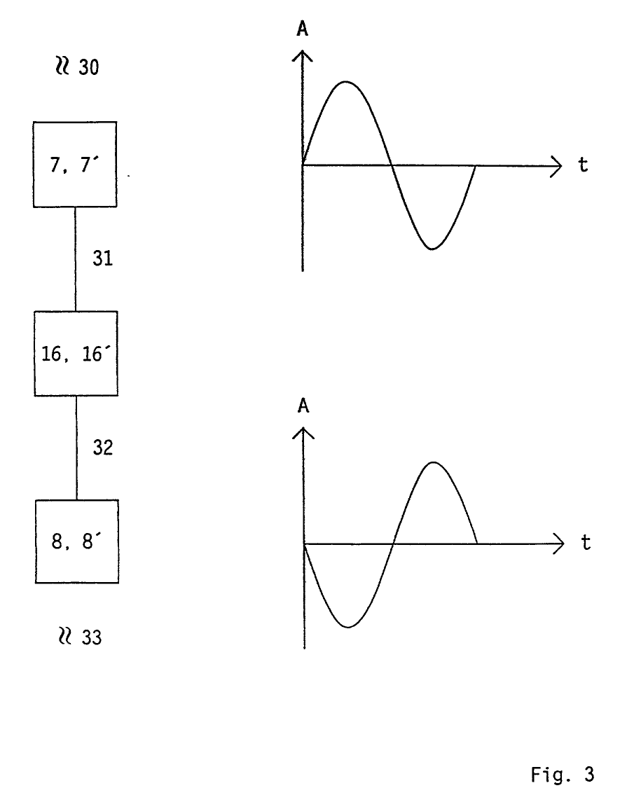

FIG. 3 shows a schematic illustration of the method of operation of the present invention. Sound waves 30 arrive at the first acoustic transducer 7, 7′, which may include a microphone, and are converted into first signals 31 that are a measure of the frequency, amplitude and phase of the sound waves 30. The first signals 31 are processed in the electronic control unit 16, 16′ and are converted into second signals 32 for noise compensation. The second signals 32 are phase-shifted 180° with respect to the first signals 31. The sound waves 30 may also be subjected to a Fourier analysis in order to break the complex sound pattern down into elementary sine waves. Such a sine wave is shown in FIG. 3.

The second acoustic transducer 8, 8′ which may, for example, include a loudspeaker, outputs compensation sound waves 33 corresponding to the second signals 32. If a Fourier analysis has been carried out, one elementary compensation wave may be emitted per elementary wave. Such an elementary compensation wave is likewise shown in FIG. 3. This has the same frequency and amplitude but the opposite phase as the associated elementary wave which is likewise shown in FIG. 3.

I claim:

1. An apparatus for active reduction of the noise emissions from a jet engine (1) having an air inlet (3), a gas outlet (4) and an engine (5) which is arranged between the air inlet (3) and the gas outlet (4), having:
(a) at least one first acoustic transducer (7, 7′) which is arranged in the air inlet (3) upstream of the engine (5), and/or in the gas outlet (4) downstream of the engine (5), for converting sound waves (30) into first signals (31) which are a measure of the frequency, the amplitude and the phase of the soundwaves (30),
(b) an electronic control unit (16, 16′) for converting the first signals (31) into second signals (32),
(c) a second acoustic transducer (8) which is arranged centrally in the air inlet (3) upstream of the engine or in a centrally arranged cone upstream of the engine, for converting the second signals (32) into compensation sound waves (33) whose frequency, amplitude and phase are such that the sound waves (30) and the compensation sound waves (33) at least partially cancel one another out and/or
(d) a second acoustic transducer (8′) which is arranged on a centrally arranged holder in the gas outlet (4) downstream of the engine (5), for converting the second signals (32) into compensation sound waves (33) whose frequency, amplitude and phase are such that the sound waves (30) and the compensation sound waves (33) at least partially cancel one another out.

2. Apparatus according to claim 1, in which at least one first acoustic transducer (7, 7′) is arranged centrally in the air inlet (3) upstream of the engine (5), and/or centrally in the gas outlet (4) downstream of the engine (5).

3. Apparatus according to claim 1, in which the air inlet (3) has, centrally, a cone (12) having at least one opening (13), in which case the first acoustic transducer (7) and the second acoustic transducer (8) are fitted in the cone (12) in such a manner that they are acoustically connected to the air inlet (3) via the opening (13).

4. Apparatus according to claim 3, in which the central cone (12) in the air inlet (3) is matched, in terms of flow mechanics, to the front end of the engine.

5. Apparatus according to claim 1, in which the gas outlet (4) has a central holder (14) for accommodating the first acoustic transducer (7′) and the second acoustic transducer (8′).

6. Apparatus according to claim 5, in which the central holder (14) is matched, in terms of flow mechanics, to the tailpiece (15) of the engine (5).

7. Apparatus according to claim 1, furthermore having a cooling device for cooling the second acoustic transducer (8′) and/or the first acoustic transducer (7′) in the gas outlet (4).

8. Apparatus according to claim 1, furthermore having a comparison unit (17, 17′) for comparing the first signals (31) from the first acoustic transducer (7, 7′) with nominal signals.

9. Apparatus according to claim 8, furthermore having an output unit for outputting a warning signal when at least one predetermined discrepancy occurs between the first signals (31) from the first acoustic transducer (7, 7′) and the nominal signals.

10. Apparatus according to claim 8, furthermore having a service monitoring unit for calculating and indicating the date when the next servicing for the jet engine (1) is due on the basis of the time behaviour of the first signals (31) from the first acoustic transducer (7, 7′) in comparison to the nominal signals.

11. Apparatus according to claim 1, characterized by a unit for synchronizing at least two jet engines (1), in which case the unit compares the first signals (31) from the first acoustic transducers (7, 7′) of the jet engines (1) with one another and, in the event of a discrepancy, varies control parameters for the jet engines (1) in such a manner that the first signals (31) from the first acoustic transducers (7, 7′) of the jet engines (1) are matched to one another.

12. Method for active reduction of the noise emission from a jet engine (1) having an air inlet (3), a gas outlet (4) and an engine (5) which is arranged between the air inlet (3) and the gas inlet (4), comprising the following steps:
(a) conversion of sound waves (30) into first signals (31) which are a measure of the frequency, amplitude and phase of the sound waves (30), in at least one first acoustic transducer (7, 7′) which is arranged in the air inlet (3) upstream of the engine (5), and/or in the gas outlet (4) downstream of the engine (5),
(b) conversion of the first signals (31) into second signals (32) in an electronic control unit (16, 16′),
(c) conversion of the second signals (32) into compensation sound waves (33) whose frequency, amplitude and phase are such that the sound waves (30) and the compensation sound waves (33) at least partially cancel one another out, in a second acoustic transducer (8) which is arranged centrally in the air inlet (3) upstream of the engine (5) or in a centrally arranged cone upstream of the engine (5) and/or
(d) conversion of the second signals (32) into compensation sound waves (33) whose frequency, amplitude and phase are such that the sound waves (30) and the compensation sound waves (33) at least partially cancel one another out, in a second acoustic transducer (8′) which is arranged on a centrally arranged holder in the gas outlet (4) downstream of the engine (5).

13. Method according to claim 12, in which the first acoustic transducer (7, 7′) in method step (a) is arranged centrally in the air inlet (3) upstream of the engine (5), and/or centrally in the gas outlet (4) downstream of the engine (5).

14. Method according to claim 12, in which the first signals (31) from the first acoustic transducer (7, 7′) are compared, in a comparison unit (17, 17′), with nominal signals.

15. Method according to claim 12, in which a warning signal is output by means of an output unit when at least one predetermined discrepancy occurs between the first signal (31) from the first acoustic transducer (7, 7′) and the nominal signals.

16. Method according to claim 12, in which the date when the next servicing of the jet engine (1) is due is calculated and indicated by a service monitoring unit on the basis of the time behaviour of the first signals (31) from the first acoustic transducer (7, 7′) in comparison with nominal signals.

17. Method according to claim 12, in which the first signals (31) from the first acoustic transducers(7, 7′) from two or more jet engines (1) are compared and, on the basis of this comparison, control parameters for the jet engines (1) are varied in such a manner that the first signals (31) from the first acoustic transducers (7, 7′) of the jet engines are matched to one another, in order in this way to synchronize the jet engines (1) to one another.

18. An apparatus for active reduction of noise emissions from a jet engine comprising an air inlet, a gas outlet, and an engine arranged between the air inlet and the gas outlet, comprising:
at least one first acoustic transducer arranged in the air inlet upstream of the engine and/or in the gas outlet downstream of the engine and configured to convert sound waves into first signals which are a measure of a frequency, an amplitude and a phase of the sound waves;
an electronic control unit configured to convert the first signals into second signals; and
at least one second acoustic transducer arranged centrally in at least one of: the air inlet upstream of the engine, a centrally arranged cone upstream of the engine, or a centrally arranged holder in the gas outlet downstream of the engine, wherein the second acoustic transducer is configured to convert the second signals into compensation sound waves, wherein the sound waves and the compensation sound waves at least partially cancel each other out.

19. The apparatus of claim 18, wherein the at least one first acoustic transducer is arranged centrally in the air inlet upstream of the engine and/or centrally in the gas outlet downstream of the engine.

20. The apparatus of claim 18, further comprising a cone having at least one opening, wherein the at least one first acoustic transducer and the at least one second acoustic transducer are fitted in the cone in such a manner that they are acoustically connected to the air inlet via the at least one opening, and wherein the cone is arranged centrally within the air inlet.

21. The apparatus of claim 20, wherein the cone is matched, in terms of flow mechanics, to a front end of the engine.

22. The apparatus of claim 18, wherein the gas outlet comprises a central holder for accommodating the at least one first acoustic transducer and the at least one second acoustic transducer.

23. The apparatus of claim 22, wherein the central holder is matched, in terms of flow mechanics, to a tailpiece of the engine.

24. The apparatus of claim 18, further comprising a cooling device for cooling the at least one second acoustic transducer and/or the at least one first acoustic transducer in the gas outlet.

25. The apparatus of claim 18, further comprising a comparison unit configured to compare the first signals with nominal signals.

26. The apparatus of claim 25, further comprising an output unit configured to output a warning signal when at least one predetermined discrepancy occurs between the first signals and the nominal signals.

27. The apparatus of claim 25, further comprising a service monitoring unit configured to calculate and indicate the date when a next servicing for the jet engine is due based on a time behavior of the first signals in comparison to the nominal signals.

28. The apparatus of claim 18, further comprising a unit configured to synchronize at least two jet engines, wherein the unit is further configured to compare the first signals with signals associated with a second jet engine and, in the event of a discrepancy, to vary control parameters for at least one of the jet engines so that the first signals are matched to the signals from the second jet engine.

29. A method for active reduction of noise emission from a jet engine comprising an air inlet, a gas outlet, and an engine arranged between the air inlet and the gas inlet, wherein the method comprises:
converting sound waves into first signals which are a measure of a frequency, an amplitude and a phase of the sound waves, wherein said converting is performed by at least one first acoustic transducer arranged in the air inlet upstream of the engine, and/or in the gas outlet downstream of the engine;
converting of the first signals into second signals in an electronic control unit;
converting the second signals into compensation sound waves, wherein the sound waves and the compensation sound waves at least partially cancel one another out, wherein said converting is performed by at least one second acoustic transducer which is centrally arranged in at least one of: the air inlet upstream of the engine, a centrally arranged cone upstream of the engine, or a centrally arranged holder in the gas outlet downstream of the engine.

30. The method according to claim 29, wherein the first acoustic transducer is arranged centrally in the air inlet upstream of the engine and/or centrally in the gas outlet downstream of the engine.

31. The method according to claim 29, further comprising comparing the first signals with nominal signals.

32. The method according to claim 29, further comprising outputting a warning signal when at least one predetermined discrepancy occurs between the first signal and the nominal signals.

33. The method according to claim 29, further comprising calculating a date when a next servicing of the jet engine is due based on a time behavior of the first signals in comparison with nominal signals.

34. The method according to claim 29, further comprising comparing the first signals to signals associated with a second jet engine and varying control parameters for the first and second jet engines in such a manner that the first signals are matched to the signals associated with the second jet engine, wherein when the first signals are matched to the signals associated with the second jet engine the jet engine is synchronized to the second jet engine.
